(19) United States
(12) Patent Application Publication
(10) Pub. No.: US 2012/0050765 A1
(43) Pub. Date: Mar. 1, 2012

(54) IMAGE PROCESSING APPARATUS, IMAGE PROCESSING METHOD, AND STORAGE MEDIUM

(75) Inventor: Hiroshi Mori, Tokyo (JP)

(73) Assignee: CANON KABUSHIKI KAISHA, Tokyo (JP)

(21) Appl. No.: 13/208,209

(22) Filed: Aug. 11, 2011

(30) Foreign Application Priority Data
Aug. 25, 2010 (JP) 2010-188499

(51) Int. Cl. H04N 1/60

(52) U.S. Cl. 358/1.9

(57) ABSTRACT

An image processing apparatus determines whether an ROP result for a region where objects overlap each other is a specific pattern. Upon a determination that the ROP result is the specific pattern, the image processing apparatus converts a color value of the region to an intermediate color indicating a transparent color.

### BACKGROUND OF THE INVENTION

1. Field of the Invention

The present invention relates to an image processing apparatus, an image processing method, and a storage medium.

2. Description of the Related Art

In recent years, as rendering functions used by various kinds of applications operating on client personal computers (PCs) and by a variety of device units have become more sophisticated, printers are required to be capable of printing high quality images rendered by using such rendering functions. In particular, functions for implementing transparency effects on objects, for example, have rapidly become popular, which requires printers to be able to produce high quality images at high speed.

In this situation, an application accomplishes a transparency effect by performing a raster operation (ROP) utilizing a checkered tile pattern.

For example, a rendering process in an Area 1 (203) illustrated in FIG. 1 will be described. In the Area 1 (203), an Object 1 (201) and an Object 2 (202) contained in a Page (200) overlap each other, and the application of a transparency effect on the Objects 1 and 2 (201 and 202) is designated. A Layer 1 (210) represents a rendering of the Object 1 (201). A Layer 2 (211) represents a rendering of the Object 2 (202). A Layer 3 (212), having a checkered tile pattern, is used to perform a transparent representation realized by a ROP.

The application processes the three layers, the Layers 1, 2, and 3 (210, 211, and 212), using a given ROP operator to obtain an output image of a Result 1 (213). The given ROP operator assigns either the color of the Layer 1 (210) or the color of the Layer 2 (211) to each portion in the checkered pattern.

For example, the color of the Layer 1 (210) is assigned to the white portions in the checkered pattern. Likewise, the color of the Layer 2 (211) is assigned to the black portions in the checkered pattern. The Result 1 (213) achieved by such an ROP operation is a checkered pattern of the colors of the Layers 1 and 2 (210 and 211), which is a transparent rendering utilizing visual effects that make the two colors look as if those colors were blended.

However, when such a rendering is performed, moiré effects occur due to interference between the pattern image and dithering processing. To solve this problem, Japanese Patent Application Laid-Open No. 2008-23960 discusses a technique in which a rendering command to fill an object with a given pattern is converted to information specifying filling of the object in a uniform density, and then the rendering is performed.

However, when a plurality of objects overlaps in a transparent representation obtained by a ROP utilizing a checkered tile pattern as in the case described above, a correct transparency effect may not be represented due to matching of the tile phases, for example.

As an example, a rendering process in an Area 2 (304) illustrated in FIG. 2 will be described. In the Area 2 (304), the Object 1 (201), the Object 2 (202), and an Object 3 (303) overlap each other, and the application of a transparency effect on the Objects 1, 2 and 3 (201, 202, and 303) is designated.

First, the overlapping portion of the Objects 1 and (201 and 202) is rendered in the manner set forth above, therefore, will not be described again here. Further, a Layer 4 (311) indicates a rendering of the Object 3 (303). The Layer 4 is processed using the Result 1 (213), the Layer 3 (212), and a given ROP operator, thereby obtaining an output image of a Result 2 (313).

For the black portions in the checkered pattern, the color of the Layer 4 (311) is selected. The color of the Result (213) is selected for the white portions in the checkered pattern. However, since, in effect, the color of the Layer 1 (210) is selected for the white portions in the Layer 3 (212), the color of the Layer 2 (211) does not appear in the Result (313). Accordingly, the user cannot obtain a transparent image as intended.

If the technique in Japanese Patent Application Laid-Open No. 2008-23960 described above is used, this problem can also be avoided. On the other hand, the technique in Japanese Patent Application Laid-Open No. 2008-23960 detects the region filling performed with a given pattern. In this detection, entire data of a tile pattern contained in a rendering command needs to be referred to pixel by pixel, which affects the performance significantly. In addition, to perform such detection during processing carried out on a command-by-command basis, a configuration for adding pixel-by-pixel referencing processing which is not conventional will be presumably provided, affecting the performance more significantly. Therefore, a new approach that can address this problem with a minimum effect on the performance needs to be taken.

Furthermore, in the technique in Japanese Patent Application Laid-Open No. 2008-23960, a determination is made based on a given pattern rendering. However, a pattern such as a checkered pattern in this technique may also be used in renderings for other applications, and thus may cause an erroneous determination. Accordingly, transparency processing that does not cause any erroneous determination also needs to be achieved.

### SUMMARY OF THE INVENTION

The present invention is directed to enabling transparency processing as intended which suppresses an influence on image processing and does not cause any erroneous determination.

According to an aspect of the present invention, an image processing apparatus includes a determination unit configured to determine whether a raster operation (ROP) result for a region where objects overlap each other is a specific pattern, and a conversion unit configured to convert a color value of the region to an intermediate color indicating a transparent color if the determination unit determines that the ROP result is the specific pattern.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a conventional technique for rendering a transparent representation.

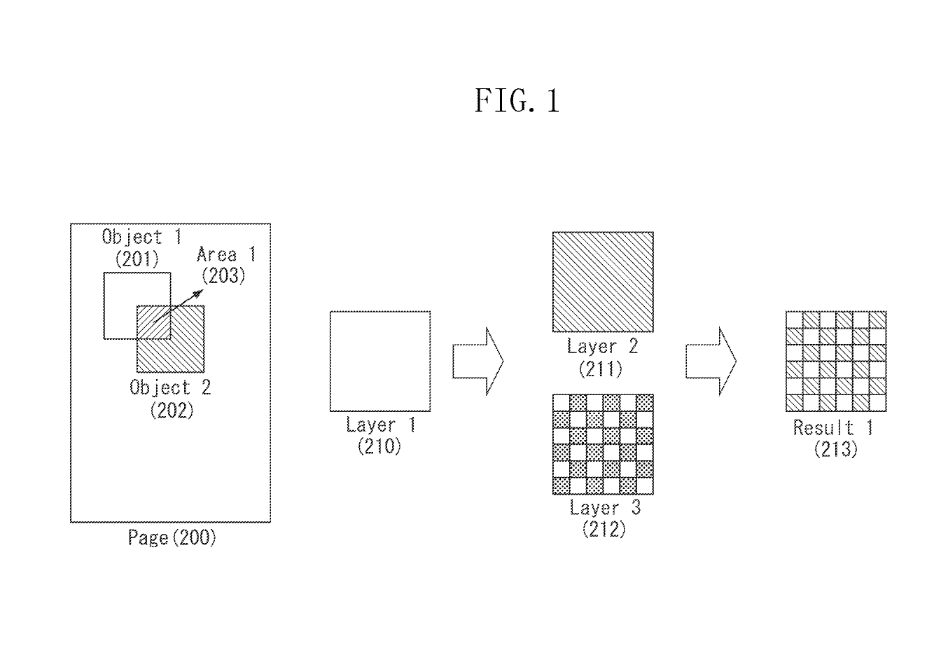

FIG. 2 illustrates an example of a problem to be solved in the conventional technique for rendering a transparent representation.

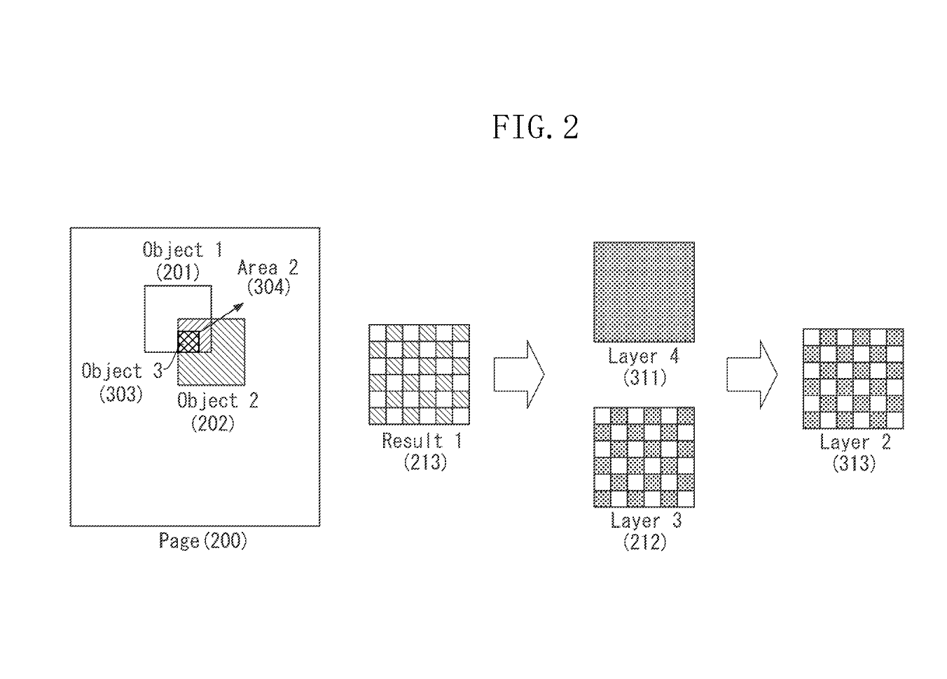

FIG. 3 illustrates an example of the hardware configuration of an image forming processing apparatus.

FIG. 4 is a flowchart illustrating an example of image generation processing.

FIG. 5 is a flowchart illustrating an example of rendering processing.

FIG. 6 illustrates SPANs indicating closed regions.

FIG. 7 is a flowchart illustrating an example of image synthesis processing.

FIG. 8 illustrates an example of synthesis control information.

FIG. 9 illustrates an example of pixel (color value) synthesis processing.

FIG. 10 illustrates an example of pixel (ROP attribute) synthesis processing.

FIG. 11 is a flowchart illustrating an example of pixel (attribute) synthesis processing.

FIG. 12 is a flowchart illustrating an example of intermediate color conversion processing.

FIG. 13 illustrates an example of a ROP attribute detection pattern table.

FIG. 14 illustrates an example of intermediate color conversion processing.

### DESCRIPTION OF THE EMBODIMENTS

Various exemplary embodiments, features, and aspects of the invention will be described in detail below with reference to the drawings.

The following exemplary embodiments will be described by taking a multi-function printer (MFP), such as an image forming processing apparatus 100, as an example of an image processing apparatus (computer). Alternatively, a single function printer (SFP), a laser beam printer (LBP), or other types of printers may also be used.

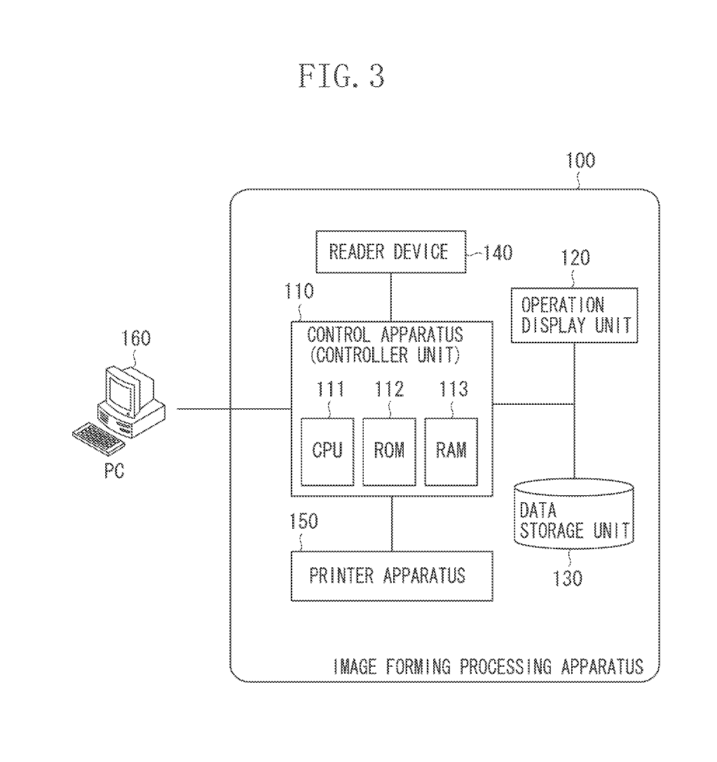

FIG. 3 illustrates an example of the hardware configuration of the image forming processing apparatus 100. The image forming processing apparatus 100 is connected with a host computer (PC) 160 through a local area network (LAN), such as an Ethernet®. The image forming processing apparatus 100 includes a reader device 140, a printer apparatus 150, an operation display unit 120, a data storage unit 130, and a control apparatus (controller unit) 110 for controlling those members.

The control apparatus 110 includes a central processing unit (CPU) 111, a read only memory (ROM) 112, and a random access memory (RAM) 113, for example. The CPU 111 controls the entire image forming processing apparatus 100 according to programs stored in the ROM 112 or other storage media. For example, the control apparatus 110 loads, into the CPU 111, respective predetermined programs for performing PDL analysis processing, intermediate language generation processing, rendering processing, and other processing. For rendering processing, dedicated hardware, which will not be described herein, may also be used.

The printer apparatus 150 outputs image data. More specifically, the printer apparatus 150 prints an image on a sheet based on bitmap data rendered and generated by the control apparatus (110). The operation display unit 120 includes a keyboard for making various print settings for performing image output processing, and a liquid crystal panel on which operation buttons for making image output settings, for example, are displayed.

The data storage unit 130 stores/retains image data, document data, and print data, such as printing device control languages (for example, escape character (ESC) codes and page description languages (PDLs)). For example, the data storage unit 130 stores/retains image data, documents, and PDLs received from the host computer (PC) 160 through the LAN, and image data read by controlling the reader device 140.

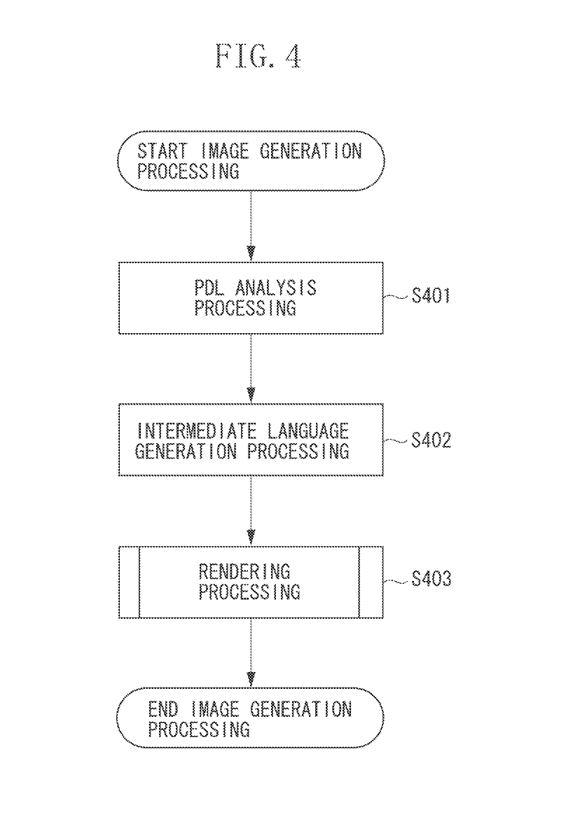

FIG. 4 is a flowchart illustrating an example of image generation processing.

First, the PC (160) transmits an instruction to print page image information written in a page description language (PDL). The image forming processing apparatus (100) stores the transmitted PDL in the data storage unit (130). Then, in step S401, to generate an image, the control apparatus (110) obtains the PDL from the data storage unit (130) and analyzes the PDL.

In step S402, the control apparatus (110) converts the analyzed PDL to a given renderable intermediate language.

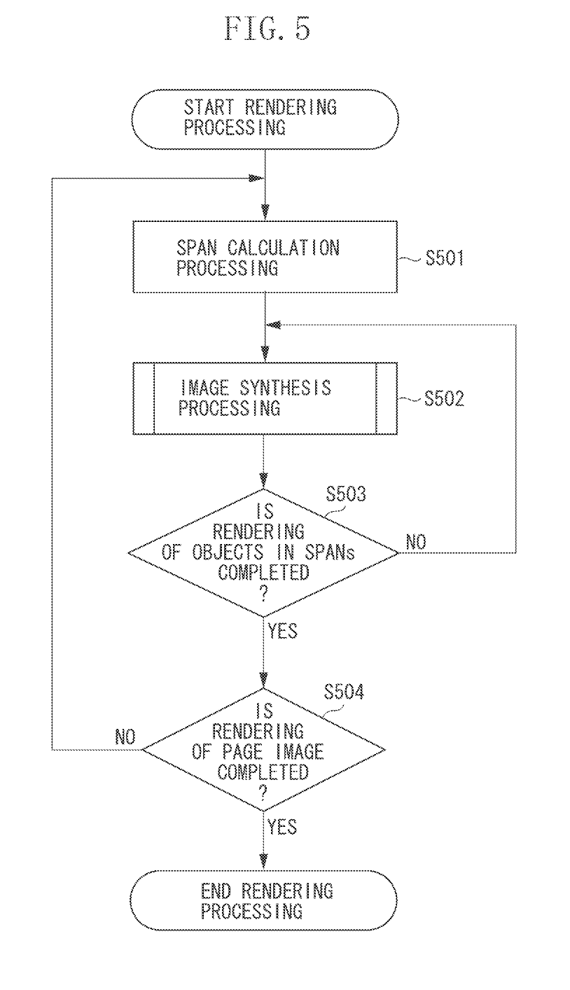

Subsequently, in step S403, the control apparatus (110) performs rendering processing based on the intermediate language generated in step S402 to generate bitmap data indicating the image of the page. The processing in step S403 will be described in detail below with reference to a flowchart illustrated in FIG. 5.

The present exemplary embodiment describes a configuration in which the control apparatus (110) performs the processing. To be specific, the CPU (111) may perform the processing, or alternatively, dedicated hardware may perform the series of processing steps.

FIG. 5 is a flowchart illustrating an example of the rendering processing.

In the present exemplary embodiment, the control apparatus (110) performs the rendering processing (step S403), for example, in units of closed regions (hereinafter referred to as “SPANs”) surrounded by the edges of objects in each scan line. First, in step S501 in the rendering processing (step S403), the control apparatus (110) performs SPAN calculation processing to calculate each SPAN from information on the edges of each object.

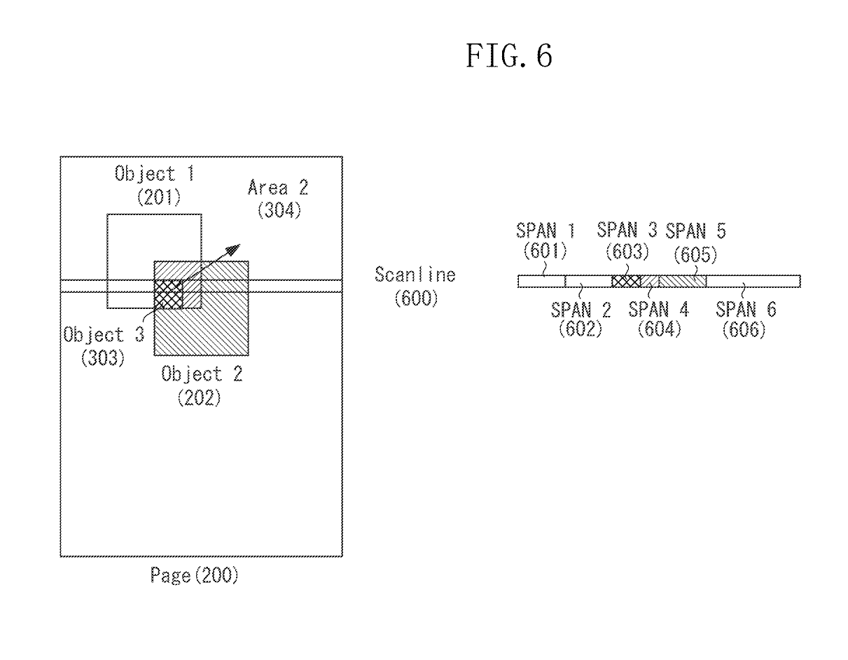

As illustrated in FIG. 6, for example, the control apparatus (110) calculates, from the edges of the objects in a Scan line (600), SPANs 1 to 6 (601 to 606) that are closed regions surrounded by those edges. The control apparatus (110) then proceeds with the processing in units of the calculated SPANs. The edge information will not be described in detail herein because such edge information has been utilized in conventional techniques.

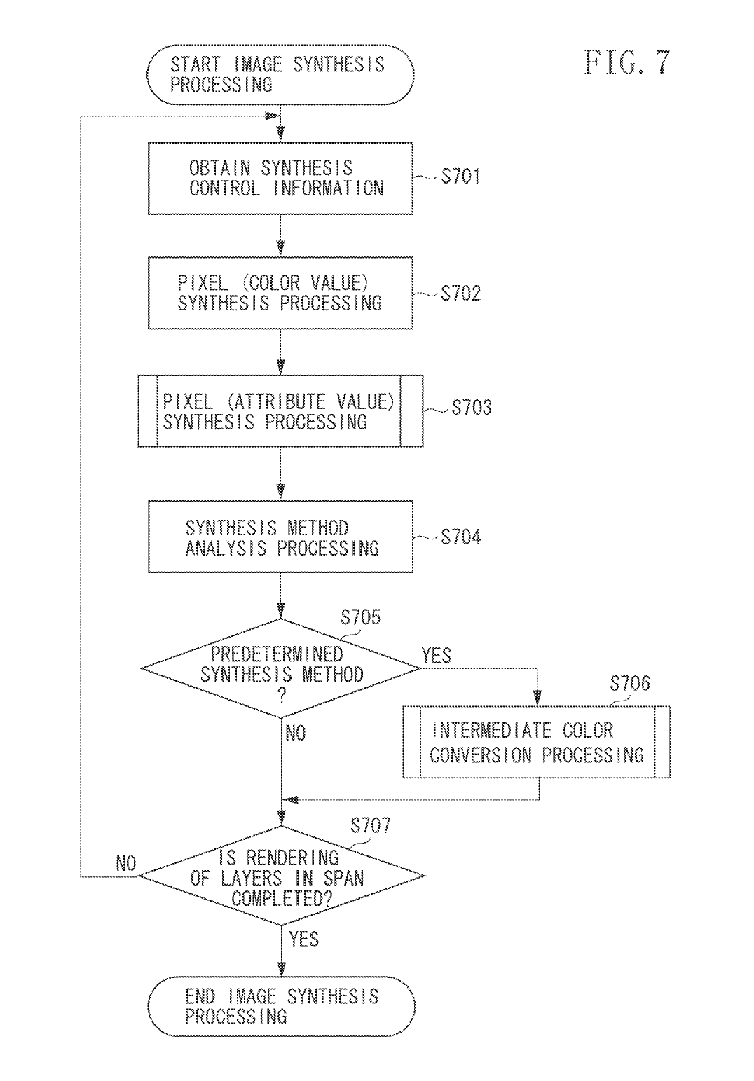

Subsequently, in step S502 in the rendering processing (step S403), the control apparatus (110) performs image synthesis processing according to information on objects overlapping in the SPANs. For example, in the SPAN 3 (603) where the three objects, the Objects 1, 2, and 3 (201, 202, and 303), overlap each other, the control apparatus (110) performs synthesis processing in sequence from the lowermost object. The processing in step S502 will be described in detail later with reference to a flowchart illustrated in FIG. 7.

Then, in step S503 in the rendering processing (step S403), the control apparatus (110) determines whether the rendering of all objects contained in the SPAN is complete. If the rendering is complete (YES in step S503), the process proceeds to step S504. If not (NO in step S503), the process proceeds to step S502.

Finally, in step S504 in the rendering processing (step S403), the control apparatus (110) determines whether the rendering of all objects contained in the page is complete. If the rendering is complete (YES in step S504), the control apparatus (110) ends the rendering processing (step S403). If not (NO in step S504), the process proceeds to step S501.

FIG. 7 is a flowchart illustrating an example of the image synthesis processing.

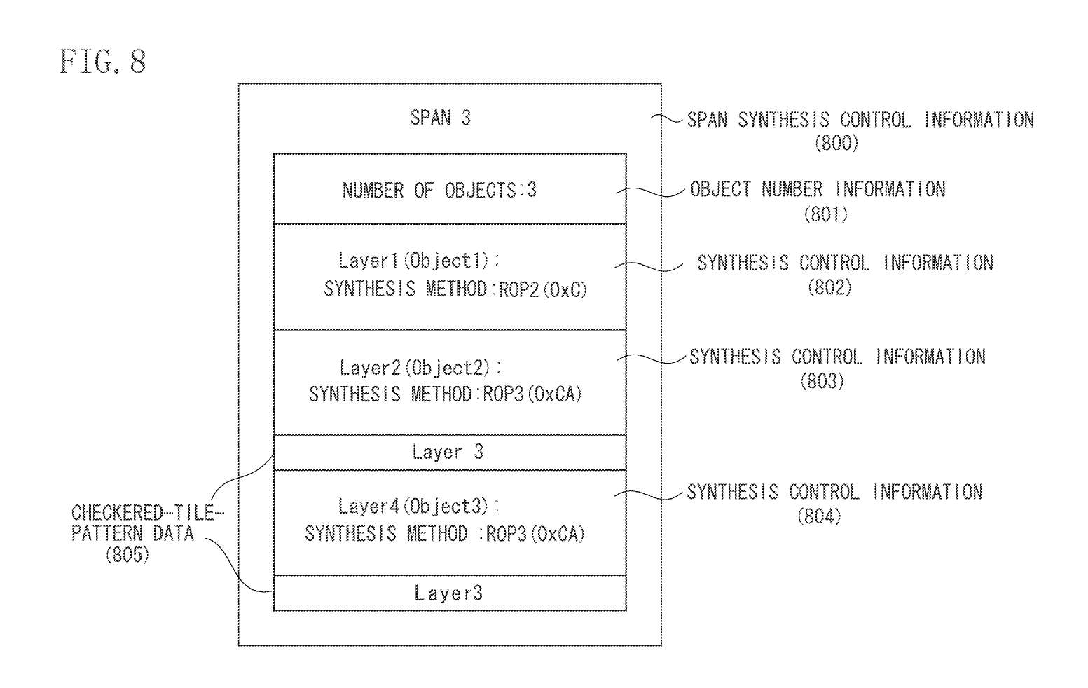

In step S701, the control apparatus (110) obtains synthesis control information indicating how to synthesize objects. For example, the synthesis control information for the SPAN 3 (603) takes the form of SPAN synthesis control information (800) illustrated in FIG. 8.

The SPAN synthesis control information (800) contains object number information (801) indicating the number of objects contained in the SPAN 3 (603). The SPAN synthesis control information (800) also contains a number of pieces of synthesis control information that correspond to the number of objects indicated by the object number information (801). Since the SPAN 3 (603) contains three objects, the SPAN synthesis control information (800) contains three pieces of synthesis control information: synthesis control information 1 (802), synthesis control information 2 (803), and synthesis control information 3 (804).

The synthesis control information 1 (802) indicates a synthesis method for the Layer 1 (210). The synthesis control information 2 (803) indicates a synthesis method for the Layer 2 (211). The synthesis control information 3 (804) indicates a synthesis method for the Layer 4 (311).

The Layers 2 and 4 (211 and 311) indicate transparent layers utilizing a checkered tile pattern. Thus, the Layers 2 and 4 (211 and 311) hold checkered-tile-pattern data (805) at the same time. Accordingly, in step S701, the control apparatus (110) obtains the synthesis control information pieces 1, 2, and 3 (802, 803, and 804) corresponding to the respective Layers 1, 2, and 4 (210, 211, and 311), to determine the synthesis methods to be carried out subsequently.

In step S702, the control apparatus (110) synthesizes the pixels (color values) according to step S701. For example, the control apparatus (110) performs color value synthesis processing such as a known raster operation (ROP).

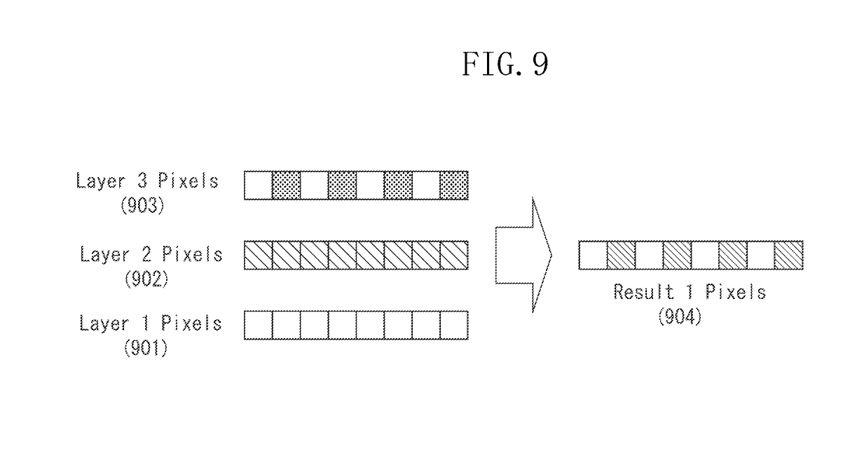

Referring to FIG. 9, an example of such color value synthesis processing will be described. Layer 1 Pixels (901) indicate the color value of the Layer 1 (210). Layer 2 Pixels (902) indicate the color value of the Layer 2 (211). Layer 3 Pixels (903) indicate the color value of the Layer 3 (212). For example, the control apparatus (110) performs a given ROP on the Layer 1 Pixels (901), the Layer 2 Pixels (902), and the Layer 3 Pixels (903) to obtain Result 1 Pixels (904) indicating the color value of the Result 1 (213).

In step S703, the control apparatus (110) calculates, pixel by pixel, an ROP attribute result based on the pixels (color values) obtained according to step S701 and the obtained synthesis control information pieces 1, 2, and 3 (802, 803, and 804). For ROP attribute calculation, a variety of proposed techniques are known. The control apparatus (110) utilizes those techniques to calculate the ROP attributes.

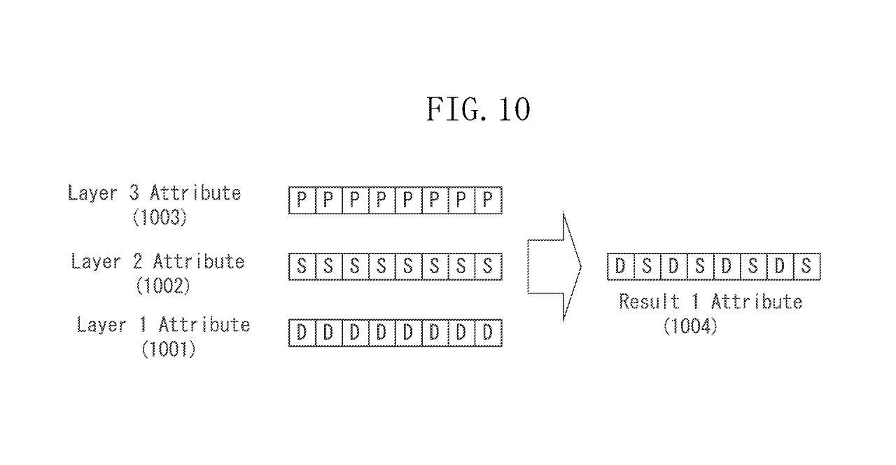

Referring to FIG. 10, the calculation will be described briefly. A Layer 1 Attribute (1001) indicates pixel-by-pixel ROP attributes (denoted by “D” in FIG. 10) of the Layer 1 (210). A ROP is performed based on layers, such as a “Destination” indicating a background, a “Source” indicating an overlying layer, and a “Pattern” indicating a pattern. Therefore, the ROP attribute is information that indicates which layer the pixel belongs to.

A Layer 2 Attribute (1002) indicates pixel-by-pixel ROP attributes (denoted by “S” in FIG. 10) of the Layer 2 (211). A Layer 3 Attribute (1003) indicates pixel-by-pixel ROP attributes (denoted by “P” in FIG. 10) of the Layer 3 (212).

The control apparatus (110) synthesizes the ROP attributes of the Layers 1, 2, and 3 (210, 211, and 212) to obtain a Result 1 Attribute (1004). As described previously, for the white portions in the Layer 3 (212), the color of the background is selected, and hence the “Destination” is also selected for the ROP attribute. For the black portions in the Layer 3 (212), since the color of the overlying layer is selected, the “Source” is selected also for the ROP attribute.

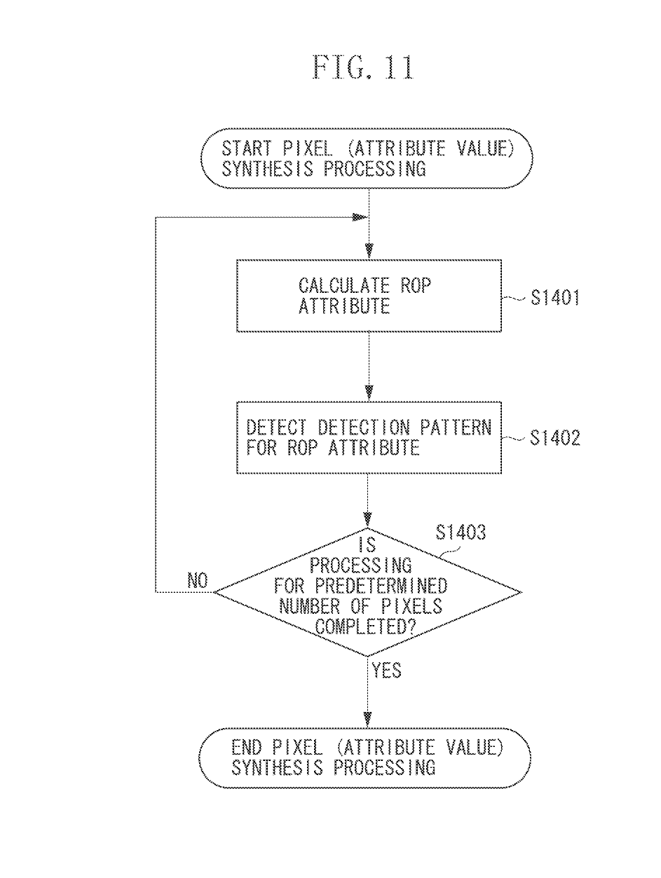

As described in steps S1401 and S1403, the control apparatus (110) performs this processing on a pixel-by-pixel basis to calculate the ROP attribute of each pixel. FIG. 11 is a flowchart illustrating an example of the pixel (attribute) synthesis processing.

Furthermore, in step S1402, the control apparatus (110) determines whether repeated ROP attributes obtained in the ROP attribute calculation indicate a specific detection pattern (1201, 1202, or 1203, which will be described later). During processing in step S1102 (to be described later), the control apparatus (110) causes the process to branch according to the result of the detection determined in step S1402. When the ROP attribute detection is performed in conjunction with the conventionally known processing in step S1401, performance degradation can be prevented. If there are multiple detection patterns to be detected, determinations for those detection patterns may be made simultaneously in this processing.

In step S704, the control apparatus (110) determines whether an ROP operator indicated by the synthesis control information is a specific ROP operator. Specifically, in step S704, the control apparatus (110) determines whether the ROP operator indicated by the synthesis control information is a ROP operator indicating the specific transparent representation described above. For example, the control apparatus (110) detects a specific ROP 3 operator (such as 0xCA) or a combination (XOR-AND-XOR) of specific ROP 2 operators indicating the transparent representation.

If the control apparatus (110) determines that the ROP operator indicates the specific synthesis method (YES in step S705), the control apparatus (110) advances the process to step S706. If not (NO in step S705), the control apparatus (110) advances the process to step S707.

In step S706, the control apparatus (110) converts the pixel data in the checkered pattern representing the transparent image to an intermediate color of uniform density. In the actual processing, the control apparatus (110) changes the way in which the transparent representation is produced, from the pseudo transparent representation rendered in the checkered pattern formed by the background and the overlying layer to an actual transparent representation using an intermediate color of uniform density. This processing will be described in detail later.

In step S707, the control apparatus (110) determines whether the rendering of all layers contained in the given SPAN in the process of rendering is completed. If the rendering is not completed (NO in step S707), the control apparatus (110) advances the process to step S701. If the rendering is completed (YES in step S707), the control apparatus (110) ends the image synthesis processing (step S502).

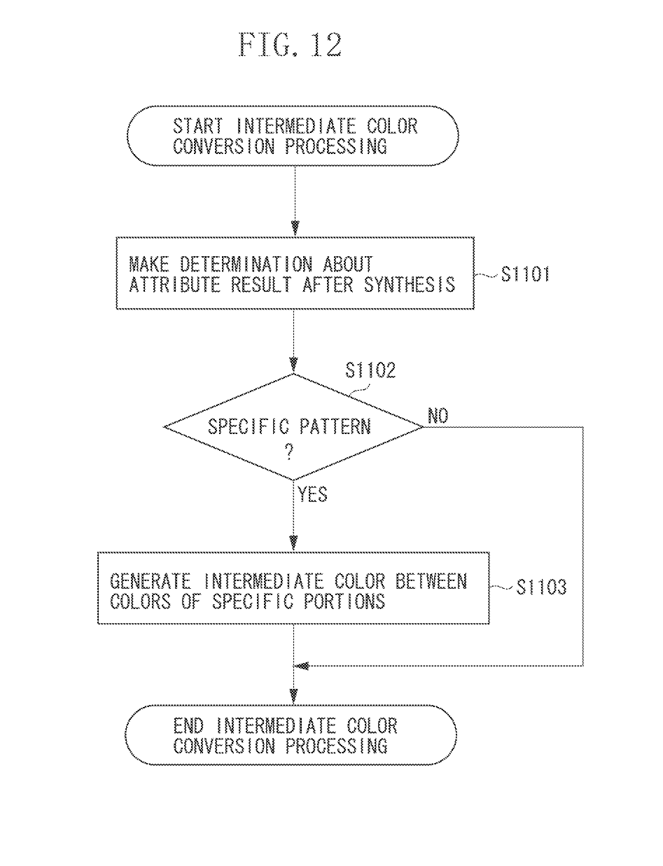

FIG. 12 is a flowchart illustrating an example of the intermediate color conversion processing.

In step S1101, the control apparatus (110) determines whether the Result 1 Attribute (1004), which indicates the ROP attribute result obtained after the synthesis processing in step S703, is a specific pattern. For example, in step S1101, the control apparatus (110) detects such a pattern by determining whether there is alternation between the “Destination” and the “Source”. If there is such alternation (YES in step S1101), the control apparatus (110) determines that the transparent representation is 50% transparent. The specific pattern may be provided in a table.

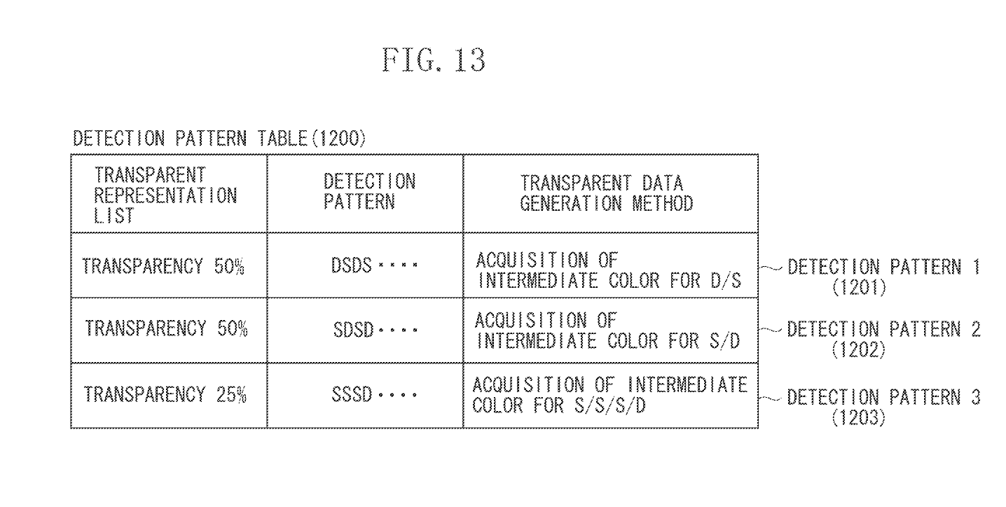

Such a table will be described with reference to FIG. 13, for example. In step S1101, the control apparatus (110) determines whether the Result 1 Attribute (1004) is a specific pattern registered as a “detection pattern” in a detection pattern table (1200) or a continuous sequence of such specific patterns. The detection pattern table (1200) is configured such that one or more patterns for any transparency ratio(s) can be registered. Hence, the detection pattern table (1200) holds one or more detection patterns, such as a detection pattern 1 (1201), a detection pattern 2 (1202), and a detection pattern 3 (1203).

In step S1102, the control apparatus (110) determines whether the ROP attribute result corresponds to a “detection pattern” in the detection pattern table (1200). If the ROP attribute result corresponds to a “detection pattern” (YES in step S1102), the control apparatus (110) advances the process to step S1103. If not (NO in step S1102), the control apparatus (110) ends the intermediate color conversion processing (step S706).

Alternatively, the processing illustrated in step S1102 may be performed during the pixel (attribute) synthesis processing in step S703. Specifically, in the configuration described above, the control apparatus (110) determines whether the Result 1 Attribute (1004) is a specific ROP attribute pattern by referring to the Result 1 Attribute (1004) pixel by pixel in the processing in step S1402. According to this result, the control apparatus (110) may perform the determination processing in step S1102 at the conventionally known processing stage to thereby prevent performance degradation.

In step S1103, the control apparatus (110) converts the pseudo transparent representation to an intermediate color indicating a transparent color of uniform density, by using a transparent data generation method corresponding to the “detection pattern” that corresponds to (or matches) the ROP attribute result. As set forth above, this is the process of converting the pseudo transparent representation rendered in the checkered pattern formed by the background and the overlying layer to an actual transparent representation using an intermediate color of uniform density.

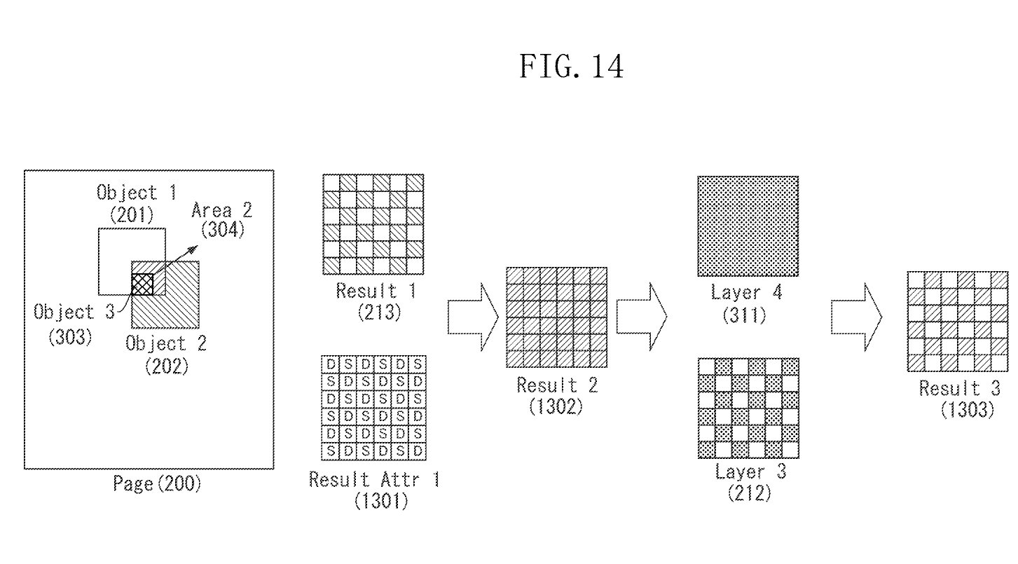

This conversion process will be described with reference to FIG. 14, as an example. A Result Attr1 (1301) is the ROP attribute result for the Result 1 (213) obtained by performing a ROP on the Layers 1, 2, and 3 (210, 211, and 212). This ROP attribute result corresponds to the detection pattern 1 or 2 (1201 or 1202), therefore, the process of obtaining an intermediate color between each pair of adjacent pixels will be described. To be specific, the control apparatus (110) converts the color value (0xFF) of the Layer 1 (210) and the color value (0x7F) of the Layer 2 (211) to a Result 2 (1302) indicating an intermediate color (0xBF) therebetween.

For example, the process for obtaining intermediate color of the detection patterns 1 and 2 (1201 and 1202) is the process of acquiring an intermediate color indicating 50% transparency. Hence, the control apparatus (110) obtains the intermediate color by using the following equation.

Intermediate color=(Color(1st)+Color(2nd))÷2

The processing expressed by this equation is the process of obtaining an intermediate color between two adjacent pixels. For example, if the Color(1st) has a color value “D”, then the Color(2nd) has a color value “S”, resulting in the process of obtaining an intermediate color between “D” and “S”. Further, the process for obtaining intermediate color of the detection pattern 3 (1203) is the process of obtaining an intermediate color indicating 25% transparency. Hence, the control apparatus (110) obtains the intermediate color by using the following equation.

Intermediate color=(Color(1st)+Color(2nd)+Color(3rd)+Color(4th))÷4

For example, if Color(1st) has the color value “S”, then the Color (2nd) and the Color (3rd) also have the color value “S”, while the Color(4th) has the color value “D”, resulting in the process of obtaining an intermediate color between “D” and “S” with 25% “D”. The conversion method employed herein is assumed to be performed in units of SPANs, however, the processing may be performed in any units. Each such conversion process is a process predetermined according to a respective pattern to be detected.

In performing the processing in this manner, a representation of the Object 3 in a checkered tile pattern, which is subsequently superimposed, is a transparent representation using the Result 2 (1302) indicating the intermediate color. Accordingly, an accurate transparency effect such as a Result 3 (1303) can be achieved.

The control apparatus (110) may also perform the intermediate color conversion processing (step S706) on the Result 3 (1303) to prevent moiré effects and other undesired effects caused by the checkered pattern and dithering. In the present exemplary embodiment, this processing is performed after the predetermined layers are superimposed, but it may also be performed before superimposing the layers.

The present invention may also be implemented by performing the following processing. Software (programs) for realizing the functions described in the foregoing exemplary embodiments is provided to a system or an apparatus through a network or various kinds of storage media. A computer (or a CPU or a microprocessor unit (MPU), for example) in the system or apparatus reads and performs the programs.

The foregoing exemplary embodiments achieve a configuration in which, in rendering a transparent representation using a ROP with a checkered tile pattern, an intended transparent image can be obtained without causing any performance degradation and erroneous determination. Accordingly, in the foregoing exemplary embodiments, intended transparency processing can be performed suppressing an influence on image processing and without causing any erroneous determination.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-188499 filed Aug. 25, 2010, which is hereby incorporated by reference herein in its entirety.

What is claimed is:

1. An image processing apparatus comprising:
a determination unit configured to determine whether a raster operation (ROP) result for a region where objects overlap each other is a specific pattern; and
a conversion unit configured to convert a color value of the region to an intermediate color indicating a transparent color if the determination unit determines that the ROP result is the specific pattern.

2. The image processing apparatus according to claim 1, wherein the specific pattern is repetition of specific attribute patterns.

3. The image processing apparatus according to claim 1, wherein if the determination unit determines that the ROP result is not the specific pattern, the conversion unit does not convert the color value of the region to the intermediate color indicating the transparent color.

4. The image processing apparatus according to claim 1, wherein the conversion unit converts the color value of the region to the intermediate color indicating the transparent color, by blending adjacent color values.

5. The image processing apparatus according to claim 1, further comprising:
a generation unit configured to generate an image based on the color value of the region; and
a print unit configured to perform printing based on the image generated by the generation unit.

6. An image processing method performed by an image processing apparatus, the method comprising:
determining whether an ROP result for a region where objects overlap each other is a specific pattern; and
converting a color value of the region to an intermediate color indicating a transparent color, if, in the determination, the ROP result is determined to be the specific pattern.

7. The image processing method according to claim 6, wherein the specific pattern is repetition of specific attribute patterns.

8. The image processing method according to claim 6, wherein if it is determined that the ROP result is not the specific pattern, the color value is not converted of the region to the intermediate color indicating the transparent color.

9. The image processing method according to claim 6, wherein the color value is converted of the region to the intermediate color indicating the transparent color, by blending adjacent color values.

10. The image processing method according to claim 6, further comprising:
generating an image based on the color value of the region; and
printing based on the image generated.

11. A storage medium storing a program for causing a computer to perform operations comprising:
determining whether a ROP result for a region where objects overlap each other is a specific pattern; and
converting a color value of the region to an intermediate color indicating a transparent color, if, in the determination, the ROP result is determined to be the specific pattern.
